(19) United States
(12) Patent Application Publication
(10) Pub. No.: US 2009/0273113 A1
(43) Pub. Date: Nov. 5, 2009

(54) Wallboard and Ceiling Tile and Method of Manufacturing Same

(76) Inventor: Mirza A. Baig, Lindenhurst, IL (US)

Correspondence Address: Mirza Baig, 479 Nuthatch Way, Lindenhurst, IL, 60046, US

(21) Appl. No.: 12/432,622

(22) Filed: Apr. 29, 2009

Related U.S. Application Data
(60) Provisional application No. 61/125,936, filed on Apr. 30, 2008.

(51) Int. Cl. C04B 16/00; B26F 1/00; C04B 28/00; B24B 1/00

(52) U.S. Cl. 264/154; 106/804; 106/779; 451/28

(57) ABSTRACT

Disclosed is a method of producing a composite material suitable for the manufacturing of gypsum wallboard and ceiling tile applications, produced by co-calcining dihydrate (gypsum) to hemihydrate/stucco and cooking of unmodified/raw starch to cooked starch together. The method disclosed improves the standard wallboard and ceiling tile processing techniques thereby lowering the manufacturing cost of both products. The co-calcining of gypsum and the unmodified starch together eliminates the calcining of dihydrate ground gypsum (powder natural or synthetic gypsum) and cooking of unmodified starch (powder) separately prior to using the materials in the wallboard and ceiling tile formulations. The unmodified starch can be also added to the gypsum rocks during the grinding and calcining process to produce composite material. Furthermore, unmodified starch can be added to the wet synthetic gypsum such as FGD (flue gas desulphurization etc.), dried or dried and calcined together. The use of composite material in both product formulations eliminates or minimizes the processing steps and lowers the energy cost by partially or completely replacing standard hemihydrate/stucco and starch during the processing.

### CROSS-REFERENCE

This application claims priority to and the benefit of Provisional Application 61/125,936, filed Apr. 30, 2008, entitled “Wallboard and Ceiling Tile and Method of Manufacturing Same”, which application is incorporated herein by reference in its entirety.

### BACKGROUND OF THE INVENTION

Conventional wallboard processing techniques consists of grinding selected sized dihydrate gypsum rocks to a desired particle size powder. Once ground, the gypsum powder is subject to heating equipment, such as a kettle, to convert the gypsum powder from dihydrate to hemihydrate or stucco. The heating process of the dihydrate gypsum is also referred as calcining. During the calcining process, some of the water inherent to gypsum, also known as combined water, is released thereby resulting in hemihydrate or stucco. The stucco can be also produced by both grinding and calcining selected sized gypsum rocks at the same time in a heating and grinding mill (alternative to calcining gypsum powder in a kettle) to minimize the process of grinding and then calcining in two separate steps. Synthetic or chemical gypsum produced by flue gas desulphurization processes and other related methods are also used in the wallboard industry.

For example, after the flue gas desulphurization process, the gypsum contains approximately 5% to 20% water. This synthetic gypsum is dried and calcined to hemihydrate and, if necessary, ground to a desired particle size after calcining. After calcining, a sufficient amount of water is re-added to the stucco to produce workable slurry. The stucco-slurry is then deposited between two sheets of papers. The slurry then sets and hardens to form boards. The boards are then cut into desired sizes and dried thus creating wallboards.

Conventional wallboard processing techniques can use additives such as accelerators, dispersants, phosphates, or starch. These additives can be added to the stucco slurry to accelerate the setting or hydration process thereby lowering the water demand needed during the mixing of the stucco to conserve energy during the drying process. Additionally, the presence of a starch in the wallboard slurry increases core strength and the strength of the bond between the core and wallboard cover sheets during the processing step after the wallboards are dried. The starch also increases the dried board hardness thereby achieving better physical properties such as flexural strength and the nail-pull values. During conventional wallboard processing, the strength enhancing starch or starches, such as acid modified starch, is added to the stucco slurry in the form of a pre-cooked starch (pre-gelatinized) powder. Alternatively, the pre-cooked starch slurry is prepared and then added to the stucco slurry to achieve an acceptable consistency during the processing.

Conventional ceiling tiles are manufactured using a felting process to construct a ceiling tile or panel from a water-based slurry. The water-based slurry is homogenous slurry consisting of a mix of different raw materials such as expanded perlite, mineral wool or slag wool, starch and paper fiber (commonly hydropulp paper fiber) and optionally inorganic material such as dihydrate gypsum or hemihydrate/stucco, calcium carbonate and clay. The water-based slurry is deposited on a continuous forming wire using a Fourdrinier or the Oliver Drum mat forming machines to form a wet mat or cake. Then the mat is wet-pressed between the two pressing rolls to a desired thickness. The pressing of the mat also serves to remove excess water. The mat is then cut to a desire size and dried. After drying, the mat is further cut into approximately 4.0-ft×4.0-ft boards or any other desired sizes. The surface is can then be ground to a desired final thickness. Finally the board surfaces are coated or painted and then cured or dried multiple times. The boards are then textured, perforated to certain depth to achieve desired sound absorption, and then cut into 2.0-ft×2.0-ft or 2.0-ft×4.0-ft, or a desired size as a final product.

Ceiling tiles can also be produced by casting a composition of the mineral wool, fillers such as gypsum (dihydrate or hemihydrate), clay, expanded perlite, and starch in a suitable tray. Normally the water-based starch slurry is pre-cooked in separate vessel at a desired consistency and then all the ingredients are added to the castable composition. Prior to depositing the composition in the tray, a paper back foil or paper is laid inside the tray to avoid the sticking of the composition to the tray during the processing and the drying. Later the composition is screeded to desired thickness with a screed bar or roller to develop a uniform or textured surface before the drying. After drying the tiles are cut into desired sizes and the face surface is coated/painted for a finished product.

### SUMMARY OF THE INVENTION

Provided herein is a method of producing a composite material comprising the steps of: calcinating a dihydrate and unmodified starch to convert the dihydrate to a hemihydrate or stucco and to further convert the unmodified starch to a cooked starch; and adding less than about 1% to about 15% unmodified starch during the calcining step of the dihydrate, wherein the adding of the unmodified starch during the calcining of the dihydrate cooks the starch. In some embodiments, the method further comprises the step of grinding the composite material to a desired particle size distribution prior to use.

Further provided herein is a method of producing a composite material comprising the step of: grinding and calcining dihydrate gypsum rocks to hemihydrate/stucco; cooking unmodified starch to cooked starch; adding less than about 1% to about 15% unmodified (uncooked-raw) starch during the calcining of the gypsum rocks cooking of starch in a grinding and calcining Mill/equipment, wherein the cooking step is done at the same time as the grinding step. The method can further comprise the step of grinding the composite material to a desired particle size distribution prior to use.

Further provided herein is a method of producing a low density gypsum ceiling tile within a density range of approximately 15.0 to approximately 25.0 pound per cubic foot comprising: using a face paper with a ceiling tile type pattern; drying the wallboard; cutting the wallboard into standard ceiling tile sizes; and perforating the pattern surface to achieve suitable NRC values. In some embodiments, the ceiling tile is adapted to minimizes or eliminate the need for a surface coating.

Further provided herein is a method of producing a composite material comprising the steps of: calcining a gypsum dihydrate with a strength enhancing additive to convert the dihydrate to a hemihydrate or a stucco and to further convert the strength enhancing additive to a cooked strength enhancing additive; and adding less than about 15% strength enhancing additive during the calcining step of the dihydrate, wherein the adding of the strength enhancing additive during the calcining of the gypsum dihydrate cooks the strength enhancing additive. The strength enhancing additive may be selected from at least one of starch or phosphate.

The partial or complete use of composite material in wallboard and ceiling tile formulations eliminates the separate step of cooking of starch. This also eliminates the starch cooking and handling systems thereby minimizing the starch cooking cost. The partial or complete elimination of starch cooking and delivery system equipment during the both wallboard and ceiling tile processing results in lower energy cost and significantly lowers the both product final cost. Cost can be reduced by replacing standard conventional wallboard and ceiling tile/panel raw materials, hemihydrate/stucco and starch with and composite material hemihydrate/stucco and cooked starch partially or completely to lower the energy cost and overall product cost. Minimizing the wallboard and ceiling tile/panel processing steps and eliminating the starch cooking step allows for the elimination of handling systems and replacing standard cost prohibitive pre-cooked starch from the formulation with composite material during the wallboard and ceiling tile/panel processing.

### DETAILED DESCRIPTION OF THE INVENTION

The invention described herein discloses a technique for minimizing the steps required to process a standard wallboard or ceiling tile. The method disclosed will further lower the costs associated with manufacturing wallboards or ceiling tile. The method discloses the process of combining the separate steps of mixing standard unmodified raw starch with ground gypsum and calcining the starch and gypsum in one step. The raw starch can be also added to selected size gypsum rock during the grinding and calcining of the gypsum to produce a desired particle size composite material. After calcining dihydrate (natural or synthetic gypsum) and starch together, or after grinding and calcining gypsum rocks and starch together, the composite material (hemihydrate or stucco and cooked starch) can be further ground to a target particle size distribution before use in the wallboard or ceiling tile formulations. Where the material is used for ceiling tile processing, the composite material can be added to the ceiling tile formulation. In some embodiments, the composite material can be re-hydrated (water based slurry) to a desired consistency prior to the addition of the composite material to the ceiling tile slurry. The partial or complete use of composite material in wallboard and ceiling tile formulations may eliminate a separate step of cooking of starch. This also eliminates the starch cooking and handling systems thereby minimizing the starch cooking cost. The partial or complete elimination of starch cooking and delivery system equipment during the both wallboard and ceiling tile processing results in lower energy cost and significantly lowers the both product final cost. Cost can be reduced by replacing standard conventional wallboard and ceiling tile/panel raw materials, hemihydrate/stucco and starch with and composite material hemihydrate/stucco and cooked starch partially or completely to lower the energy cost and overall product cost. Minimizing the wallboard and ceiling tile/panel processing steps and eliminating the starch cooking step allows for the elimination of handling systems and replacing standard cost prohibitive pre-cooked starch from the formulation with composite material during the wallboard and ceiling tile/panel processing.

### A. Wallboard

The gypsum wallboard can be produced using a partial or complete composite material. The composite material may include, but is not limited to, stucco or cooked starch. The wallboard can be produced with less than approximately 1.0% to less than approximately 15% cooked starch during the calcining of the dihydrate. The wallboard formulation can further comprise at least one of dry paper fiber, hydropulped paper fiber, additional additives such as, for example accelerators, retardants (to control the setting), consistency reducers, foam, foaming agents, any combination thereof, or any other suitable additive. Expanded perlite can be also added to the composite material wallboard slurry during the processing. The wallboards can be produced at a density range of between approximately 15.0 to approximately 50.0 pounds per cubic foot (pcf), between approximately 12.5 to approximately 65.0 pounds per cubic foot, or to any suitable density range needed which may or may not depend upon the end usage of the product. The thickness of wallboard could be between approximately ¼ of an inch to approximately 1.0 inch, between ⅛ of an inch to 1.5 inches, or any other suitable thickness.

By way of example only, a wallboard may have the formulation listed in Table 1.

TABLE 1
Wallboard Formulation Range:

| | |
|---|---|
| Hemihydrate: | 50.0%-95.0% (including cooked starch during calcining |
| | less than 1%-15% based on gypsum weight) |
| Expanded | Less than 1.0%-30.0% |
| Perlite: | |
| Cellulose | 1.0%-15.0% |
| fiber: | |
| Starch: | Less than 1.0% to 15.0% |
| Additives: | As needed (Accelerators, Retarders, Dispersants, |
| | Phosphates etc) |

### B. Ceiling Tile

In some embodiments, the ceiling tile disclosed herein can be produced using a composite material including a homogeneous water based slurry comprising expanded perlite, paper fiber (dry or hydropulp) mineral (optional) and composite material of calcined gypsum (hemihydrate/stucco and less than approximately 1% to approximately 15% starch) in the formulation. In some embodiments, the gypsum can be calcined with starch. In some embodiments, the gypsum can be calcined with any suitable strength enhancing additive including, but not limited to, phosphates, starch, any other suitable strength enhancing additive, or any combination thereof. The composite material, cooked starch and hemihydrate/stucco can then be added to a standard ceiling tile slurry. Alternatively, a composite material can be mixed in water to a desired consistency separately prior to adding the composite material, cooked starch, and hemihydrate/stucco into ceiling tile slurry. The density of the ceiling tile/panel can be between approximately 10.0 to approximately 25.0, between approximately 9.0 to approximately 27.5 pounds per cubic foot (pcf) and have a thickness of between approximately 0.5 inch to approximately 1.0 inch, between 0.25 inch to 1.25 inch thickness.

In some embodiments, the ceiling tiles can further be produced by mixing mineral wool, filler, and starch with the composition of hemihydrate and the cooked starch or other suitable strength enhancing additive known in the art, at a desired consistency prior to casting and drying the total composition in a tray. In some embodiments, the standard material gypsum includes, but is not limited to, dihydrate or hemihydrate. The starch can be replaced with the composite material of the gypsum previously described. The starch may be partially or fully replaced by the composite material. In some embodiments, any standard materials can be replaced with the composite material in total. The composite material can be used to save energy, improve and lower the product costs. Further, the method provided herein further provides a means for conserving energy and lower finishing costs.

By way of example only, a ceiling tile may have the formulation listed in Table 2.

TABLE 2
Ceiling Tile Formulation Range:

| | |
|---|---|
| Mineral | 0.0%-90.0% |
| wool: | |
| Expanded | 0.0%-75.0% |
| Perlite: | |
| Paper Fiber: | 0.0%-30.0% |
| Starch: | Less than 1.0%-15.0% |
| Hemihydrate | 0.01%-30.0% (including cooked starch from less than 1%- |
| Composite: | 15%, based on gypsum weight) |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of producing a composite material comprising the steps of:
calcining a dihydrate and unmodified starch to convert the dihydrate to a hemihydrate or stucco and to further convert the unmodified starch to a cooked starch; and
adding less than about 1% to about 15% unmodified starch during the calcining step of the dihydrate,
wherein the adding of the unmodified starch during the calcining of the dihydrate cooks the starch.

2. The method of claim 1 further comprising the step of grinding the composite material to a desired particle size distribution prior to use.

3. A method of producing a composite material comprising the step of
grinding and calcining dihydrate gypsum rocks to hemihydrate/stucco
cooking unmodified starch to cooked starch.
adding less than about 1% to about 15% unmodified (uncooked-raw) starch during the calcining of the gypsum rocks cooking of starch in a grinding and calcining mill/equipment,
wherein the cooking step is done at the same time as the grinding step.

4. The method of claim 3 further comprising the step of grinding the composite material to a desired particle size distribution prior to use.

5. A method of producing a low density gypsum ceiling tile within a density range of approximately 15.0 to approximately 25.0 pound per cubic foot comprising
using a face paper with a ceiling tile type pattern;
drying the wallboard;
cutting the wallboard into standard ceiling tile sizes; and
perforating the pattern surface to achieve suitable NRC values.

6. The gypsum based ceiling tile of claim 5 wherein the ceiling tile is adapted to minimizes or eliminate the need for a surface coating.

7. A method of producing ceiling tile comprising replacing standard materials gypsum and starch gypsum with a composite material during a water felting process.

8. The method of claim 7 wherein the standard materials gypsum is partially replaced.

9. The method of claim 7 wherein the standard material gypsum is completely replaced.

10. The method of claim 7 wherein the ceiling tiles are cast-able ceiling tiles.

11. A method of producing a composite material comprising the steps of:
calcining a gypsum dihydrate with a strength enhancing additive to convert the dihydrate to a hemihydrate or a stucco and to further convert the strength enhancing additive to a cooked strength enhancing additive; and
adding less than about 15% strength enhancing additive during the calcining step of the dihydrate,
wherein the adding of the strength enhancing additive during the calcining of the gypsum dihydrate cooks the strength enhancing additive.

12. The method of claim 11 wherein the strength enhancing additive is selected from at least one of starch or phosphate.
